(19) United States
(12) Patent Application Publication
(10) Pub. No.: US 2009/0296948 A1
(43) Pub. Date: Dec. 3, 2009

(54) MPD custom ear communication device

(75) Inventor: Mark Hood, Colorado Springs, CO (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Big Ear, Inc., Colorado Springs, CO (US)

(21) Appl. No.: 12/455,271

(22) Filed: May 29, 2009

Related U.S. Application Data
(60) Provisional application No. 61/130,289, filed on May 29, 2008.

(51) Int. Cl. G10K 11/16

(52) U.S. Cl. 381/71.6; 381/151

(57) ABSTRACT

A unique communication management device allows the user to control his/her sound environment both in and outside the ear. The device overcomes previous shortcomings encountered by emergency first responders, military, SWAT, firefighters, police, sports enthusiasts, musicians, as well as other users, with respect to single application headsets by utilizing a combination of an ambient noise microphone, volume control, compression circuit, and audio transducer. In an embodiment of the invention, the device also includes independent left and right on/off switches and one or more bone conduction microphones.

### BACKGROUND

Ear buds provide a function of sound replication, i.e., they act as speakers, in addition to providing, in many cases, some level of hearing protection or isolation. However, products currently available in the marketplace are of a generic nature and in most cases do not fit the average wearer adequately, if at all. The resulting functionality of generic ear buds is thus poor, and the sound quality often fails to meet consumer expectations.

Another prevalent problem associated with ear bud style products is that once placed in the ear and sealed in the ear canal, with the volume set to a safe and comfortable level, external sounds become muffled or inaudible, leaving the user unable to safely navigate their surroundings. With a poor fit, this problem is somewhat mitigated. However, in this case, the level of ambient sound will have a direct affect on the amount of volume needed for the user to be able to hear the intended sound source.

### BRIEF SUMMARY OF THE INVENTION

This patent application is for a unique communication management device that allows the user to control his/her sound environment both in and outside the ear. The device overcomes all previous shortcomings encountered by emergency first responders, military, SWAT, firefighters, police, sports enthusiasts, musicians, as well as other users, to overcome usage limitations encountered with single application headsets.

Other objects and advantages of the invention will become apparent upon reading the following detailed description and upon reference to the drawings.

### BRIEF DESCRIPTION OF THE SEVERAL VIEWS OF THE DRAWINGS

FIG. 1 is a diagram of an ear piece set according to an embodiment of the invention;

FIG. 2 is a reduced schematic diagram of the ear piece set according to FIG. 1;

FIG. 3 is a diagram of a further ear piece set according to an embodiment of the invention; and

FIG. 4 is a reduced schematic diagram of the ear piece set according to FIG. 3.

### DETAILED DESCRIPTION OF THE INVENTION

Consider a person standing in a subway with their friends, wearing ear buds. The volume of the audio device may be set to a level such that the person is able to hear music playing through their ear buds, but they can also hear the conversation of their friends. Increasing the volume in the ear buds will block the conversation from being heard, allowing the user to focus on the music. Now consider that as a subway train arrives, greatly increasing the ambient noise level, the volume to which the user had increased the volume to block the conversation is no longer enough. Thus, the volume through the ear buds must be increased further to enable the music to be heard above the sound of the train. As the volume increases to overcome ambient noise, the user begins to damage their hearing in a permanent, irreversible and yet preventable manner.

Not only can poorly fitting ear buds cause hearing damage in this way, but they may also create a hazardous condition for the user and those around them. For example, consider an emergency first responder at an accident scene wearing a radio connected to their ears via a headset. In a noisy accident scene, the user has to turn the radio volume up excessively to hear critical transmissions. However, the user is now hindered or disabled from hearing sounds around them such as cries for help, people speaking, warning bells and sirens, and other such external environmental sounds. Recognizing this, a skilled user may periodically take off their headset or reduce the volume. However, this action creates the risk of missing critical transmissions. In other words, in order to listen for pleas for help or hear verbal orders, the user must either take out the headset, or turn the volume down so low that they are now isolated from hearing radio signals from team members and management personnel. Thus, the ill-fitting ear wear forces the user to choose between two unsatisfactory and unsafe alternatives.

Further consider the case of a SWAT or police officer situated on a stakeout, wearing a radio earpiece in order to hear command communications. Moreover, the user would like to monitor subtle ambient noises for sounds of danger, but is prevented by the ear piece from hearing such sounds. Moreover, if the user's weapon or other nearby weapon is suddenly discharged, there is a high probability of hearing damage. The user is forced to choose between hearing tactical commands, protecting their hearing from sudden noise, or listening for danger.

Similarly, a user on a motorcycle may decide to listen to your music via a headset, which may also protect their hearing by isolating them from wind noise. However, the user is now not able to communicate with a fellow rider on the same machine or a nearby machine, and is also less able to hear nearby important environmental noises such as a siren, a dog barking, or police commands.

The invention overcomes the many shortcomings of current systems and allows the user to:

1. Manage the sound in their ear,

2. Manage the sound outside the ear,

3. Communicate via a “no wire” Bluetooth device,

4. Speak clearly via a microphone,

5. Prevent sudden noises (like gun shots, siren blasts, etc.) by instantly shutting off noise as it occurs, and

6. Restore normal hearing when the noise subsides to safe levels.

In general use, the device increase user safety by reducing the amount of volume required to listen to a source, allowing the wearer to detect the ambient sounds all around them, and be safe and provide hearing protection in environments where sudden noise protection is needed.

A traditional speaker requires air to turn an electronic signal into a sound wave for the transfer of energy to the bones in the ear to be heard. This is because the speaker creates a sound wave in the air, and both air and a certain amount of air movement are required for such a wave to propagate. In contrast, the audio micro transducer used within the invention does not require air to generate sound energy. The invention thus enables placement of the transducer into a custom mold of an individual's ear to completely block harmful ambient sound. This provides a sufficient reduction of sound to protect a wearer up to levels of, for example, 110 dBa.

The following combination of components in an embodiment of the invention, integral to the device, will provide the wearer the ability to hear outside noise:

1. Ambient Noise Microphone

When powered ON, will pick up the outside noise and transfer that information to the inner ear canal.

2. Volume Control

This mini pot will allow the wearer to increase or decrease to an off position, the amount of volume needed to reproduce sound for that individual's amount of hearing loss, if any.

3. Compression Circuit

This micro processor measures the amount of sound being picked up by the ambient noise microphone, measures the frequency and amplitude of that sound, and controls how much of the sound is transferred to the transducer to supply sound to the wearer. The ambient noise microphone will, within 1.1 to 1.3 milliseconds, measure the sound pressure level of monitored noise and determine how much compression is needed, and regulate how much sound is passed to the transducer for sound delivered into the ear canal. This device is also programmable to receive information provided by the wearer to help in amplification of reduced frequencies due to a wearer hearing loss. For example, older users may suffer deterioration in their ability to perceive higher frequency sounds.

4. Audio transducer

This device will receive the signal from the compression circuit and will reproduce the sound supplied and transfer sound to the inner ear canal.

5. Battery Door and Battery

This supplies the power source to the inside of the earpiece and is the power source location for the ambient noise microphone, compression circuit. In an embodiment of the invention, this is also the location for programming the compression circuit for response calculations and frequency amplification.

The device according to an embodiment of the invention may also include a number of optional components including:

A. On/Off Switch

This switch will energize the compression circuit, which will allow the wearer to choose to have the ambient noise microphone on or off, both on or both off. In an embodiment of the invention, each ear piece is independent and can be selected or deselected independently.

B. Bone Conduction Microphone

This additional component will pick up the vibration of sound from the vocal cords in the inner ear canal and transmit those vibrations through a microphone to a communication device or cell phone. This will allow the wearer to engage in transmit, receive and ambient noise applications. In an exemplary consumer application, this feature is useful for cell phone conversation, while allowing the user to hear outside information and remain safe and protected from loud noise environment.

An exemplary military and first responder application would encompass the use of 2 way radio communications and silent radio transmissions to enable mission critical communications without interference or detection.

C. Cord Control

A water proof control location, useful for police, fire rescue, first responder and military, is also provided in an embodiment of the invention. This application will allow all of the controls to be removed from the earpiece and placed onto a wired control housing, primarily to provide the ability to protect from moisture or submersion into fluid, but also to increase size of the controls and enhance the ability to use controls with a gloved hand.

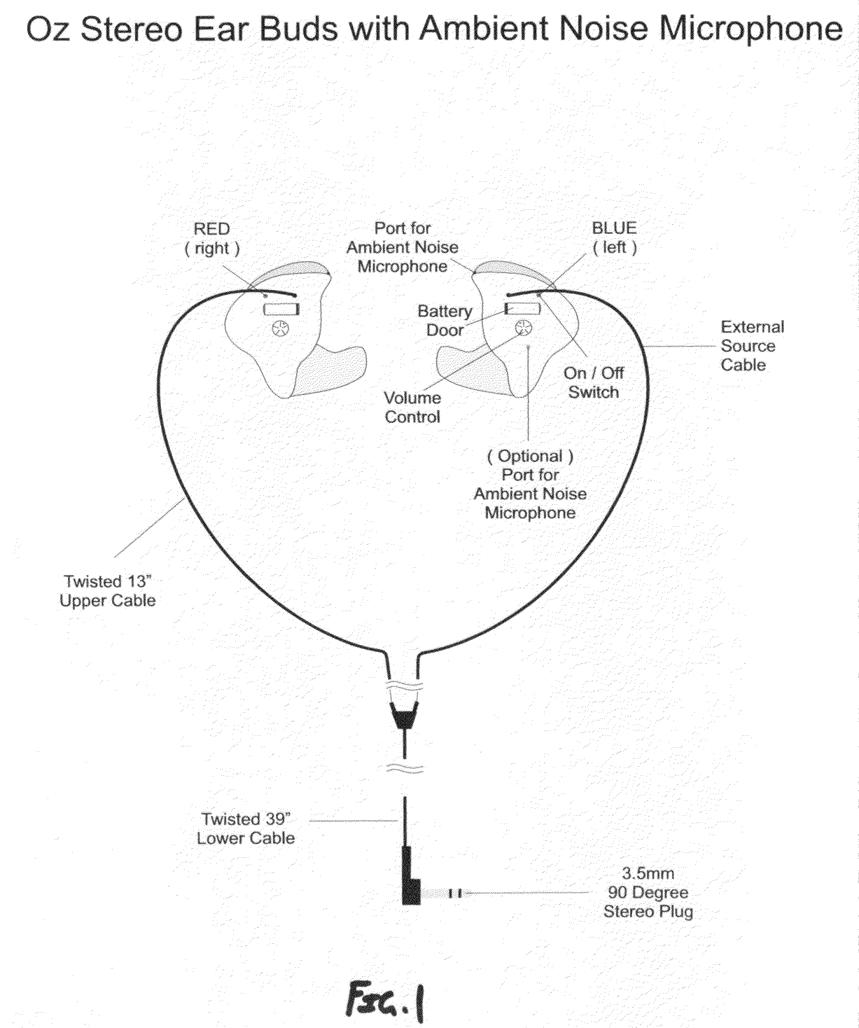

The attached drawings show exemplary devices and configurations within embodiments of the invention for the sake of clarification. Referring to FIG. 1, there is shown an ear piece set according to an embodiment of the invention. The illustrated set includes a volume control as well as an on/off switch. One or more battery doors are provided. In addition, an external source cable communicates an electrical reproduction of the intended sound to each earpiece. One or both ear pieces may further comprise one or more optional ports for an ambient noise microphone. The external source cable may terminate in a suitable jack or plug, such as, for example, a 3.5 mm 90 degree stereo plug.

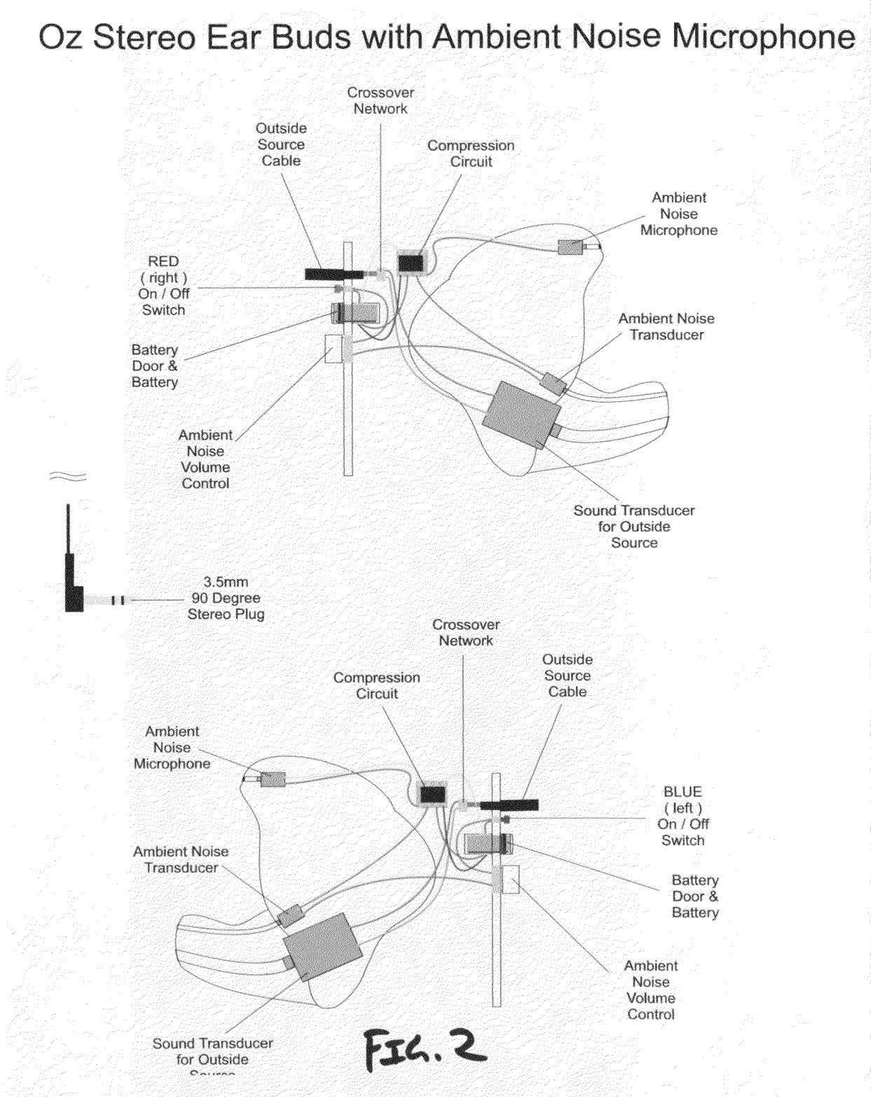

FIG. 2 shows a reduced schematic of the set shown in FIG. 1. In the view of FIG. 2, the elements described above may be seen. In addition, this view shows an ambient noise microphone, an ambient noise volume control, a crossover network, a compression circuit, an ambient noise transducer, and a sound transducer for outside source. In an embodiment of the invention, the crossover network enables coordination between the ambient noise and the supplied external source noise.

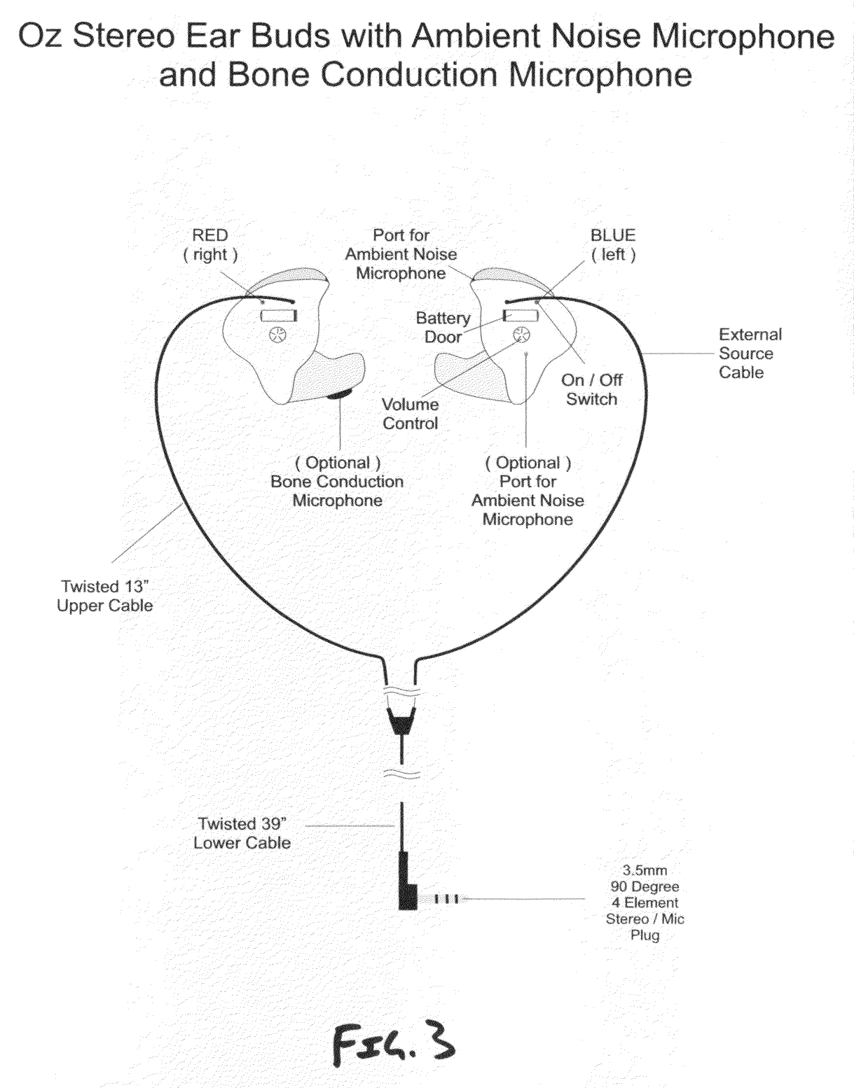

FIG. 3 shows a set similar to that shown in FIG. 1, but also including an optional bone conduction microphone according to an embodiment of the invention. The optional bone conduction microphone allows the user's speech to be airlessly detected and converted to an electrical signal for transmission.

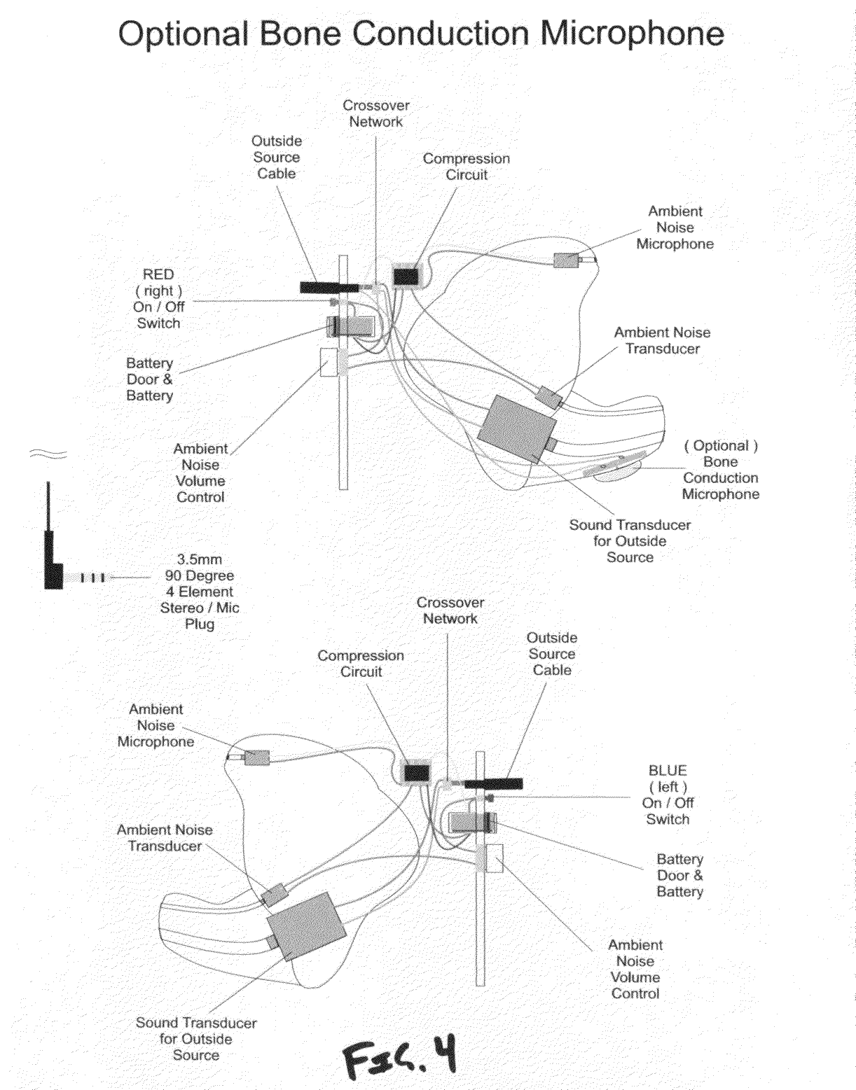

FIG. 4 shows a reduced schematic of the set shown in FIG. 3. The view of FIG. 4 shows the elements associated with FIG. 3 and also shows several additional elements such as an ambient noise microphone, an ambient noise volume control, a crossover network, a compression circuit, an ambient noise transducer, and a sound transducer for outside source.

It will be appreciated that the foregoing systems and implementations are merely examples. However, it is contemplated that other implementations of the invention may differ in detail from foregoing examples. As noted earlier, all references to the invention are intended to reference the particular example of the invention being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A headset for conveying sound to a user via asset of one or more ear pieces, each ear piece comprising:
an ambient noise microphone to detect ambient noise and transfer that information to the inner ear canal;
a volume control switch for controlling volume of noise reproduced in the ear piece;
a compression circuit; and
an audio transducer.

2. The headset according to claim 1, wherein the ambient noise microphone further comprises a switch so that the ambient noise microphone may be enabled or disabled.

3. The headset according to claim 1, wherein the volume control switch for controlling volume of noise reproduced in the ear piece further comprises a mini pot allowing the wearer to increase or decrease the volume of reproduced sound.

4. The headset according to claim 1, wherein the compression circuit further comprises a micro processor for measuring the amount of sound being picked up by the ambient noise microphone, measuring the frequency and amplitude of that sound, and controlling how much of the sound is transferred to the transducer to supply sound to the wearer.

5. The headset according to claim 1, wherein the compression circuit is also programmable to receive information provided by the wearer to help in amplification of reduced frequencies due to a wearer hearing loss.

6. The headset according to claim 1, wherein the audio transducer receives a signal from the compression circuit and reproduces the sound to the inner ear canal.

7. The headset according to claim 1, further comprising a bone conduction microphone to pick up the vibration of sound from the vocal cords in the inner ear canal and transmit those vibrations through a microphone to a communication device or cell phone.
